(19) United States
(12) Patent Application Publication
(10) Pub. No.: US 2023/0071671 A1
(43) Pub. Date: Mar. 9, 2023

(54) ELECTRODE ASSEMBLY AND MANUFACTURING METHOD OF THE SAME

(71) Applicant: LG Energy Solution, Ltd., Seoul (KR)

(72) Inventors: Seok Hoon Jang, Daejeon (KR); Hyeok Jeong, Daejeon (KR); Byeong Kyu Lee, Daejeon (KR); Su Taek Jung, Daejeon (KR); Soon Kwan Kwon, Daejeon (KR)

(73) Assignee: LG Energy Solution, Ltd., Seoul (KR)

(21) Appl. No.: 17/939,464

(22) Filed: Sep. 7, 2022

(30) Foreign Application Priority Data
Aug. 12, 2021 (KR) 10-2021-0106973

(51) Int. Cl. H01M 10/0583; H01M 10/052

(52) U.S. Cl. CPC H01M 10/0583; H01M 10/052

(57) ABSTRACT

An electrode assembly includes a stack, in which a plurality of electrodes and a plurality of separators are alternately stacked on each other and edges of the separators protrude further outward than the electrodes, and a wrapping separator, which surrounds the stack. The edges of at least some of the plurality of separators may be fused with the wrapping separator to form fused portions.

### CROSS REFERENCE TO RELATED APPLICATIONS

This application claims the priority of Korean Pat. Application No. 10-2021-0106973 filed on Aug. 12, 2021, in the Korean Intellectual Property Office, the disclosure of which is incorporated herein by reference.

### BACKGROUND OF THE INVENTION

### Field of the Invention

The present invention relates to an electrode assembly and a method for manufacturing same, and more particularly, to an electrode assembly for a secondary battery and a method for manufacturing same.

### Description of the Related Art

In general, secondary batteries refer to chargeable and dischargeable batteries unlike primary batteries that are not chargeable, and have been widely used in electronic devices, such as mobile phones, laptops, and camcorders, or electric vehicles, etc. In particular, a lithium secondary battery has a larger capacity than a nickel-cadmium battery or a nickel-hydrogen battery and has a high energy density per unit weight, and thus the degree of utilization of the lithium secondary battery is rapidly increasing.

The lithium secondary batteries are classified according to the configuration of an electrode assembly having a structure of positive electrode/separator/negative electrode. Representative examples include a jelly-roll electrode assembly having a structure in which long sheet-shaped electrodes are wound while separators are disposed therebetween, a stack-type electrode assembly having a structure in which a plurality of electrodes cut into a certain size are sequentially stacked with separators therebetween, and a stack/folding-type electrode assembly having a structure in which bi-cells or full-cells formed by stacking electrodes of a predetermined unit with separators disposed therebetween are wound.

Recently, the secondary battery cell having a structure in which the stack-type electrode assembly is embedded in a pouch-type battery case of an aluminum laminate sheet has attracted much attention due to low manufacturing cost, light weight, easy shape deformation, and the like, and according, its use is gradually increasing.

However, when the overall length of the stack-type electrode assembly is increased, bending may occur in the electrode assembly due to insufficient adhesion between the electrode and the separator. Also, this may cause interference between the battery case and the electrode assembly. Therefore, in order to prevent the bending, a configuration for increasing the stiffness of the electrode assembly is required.

### Related Art Document

### Patent Documents

KR 10-2020-0058222 A (published on May 27, 2020)

### SUMMARY OF THE INVENTION

An aspect of the present invention provides an electrode assembly having improved stiffness and a method for manufacturing same.

According to an aspect of the present invention, there is provided an electrode assembly including: a stack in which a plurality of electrodes and a plurality of separators are alternately stacked on each other, and edges of the separators protrude further outward than the electrodes; and a wrapping separator configured to surround the stack. The edges of at least some of the plurality of separators may be fused with the wrapping separator to form fused portions.

The wrapping separator may have the same material as the separators.

The wrapping separator may include: a pair of unfused surfaces configured to cover both surfaces of the stack; and a pair of fused surfaces configured to cover both sides of the stack in the width direction and connect the pair of unfused surfaces to each other, wherein the fused portions are formed in the fused surfaces.

The fused portions may be in contact with or adjacent to ends of at least some of the plurality of electrodes.

The widths of the fused portions in the width direction of the stack may be variable along a stacking direction of the stack.

The length of the wrapping separator in the longitudinal direction of the stack may be greater than about 0.5 times the full length of the stack.

The wrapping separator may be provided in plurality, and the plurality of wrapping separators may be spaced apart from each other in the longitudinal direction of the stack.

The lengths of the fused portions in the longitudinal direction of the stack may be less than or equal to the length of the wrapping separator.

According to another aspect of the present invention, there is provided a method for manufacturing an electrode assembly, the method including: preparing a stack in which a plurality of electrodes and a plurality of separators are alternately stacked on each other, and edges of the separators protrude further outward than the electrodes; wrapping a wrapping separator around the stack; and fusing the edges of at least some of the plurality of separators with the wrapping separator by using a laser beam.

During the wrapping, the wrapping separator may cover both surfaces of the stack and both sides thereof in the width direction.

The fusing may include: focusing the laser beam in a line shape on the outer surface of the wrapping separator; and performing scanning while moving the laser beam in the longitudinal direction of the stack.

The edges of the plurality of separators may be pressed and folded by the wrapping separator during the wrapping, and the edges of at least some of the plurality of separators may be fused, in a curved or bent state, with the wrapping separator during the fusing.

### BRIEF DESCRIPTION OF THE DRAWINGS

The above and other aspects, features and other advantages of the present invention will be more clearly understood from the following detailed description taken in conjunction with the accompanying drawings, in which:

FIG. 1 is a perspective view of an electrode assembly according to an embodiment of the present disclosure;

FIG. 2 is a cross-sectional view taken along line A-A′ of FIG. 1;

FIG. 3 is a flowchart of a method for manufacturing an electrode assembly according to an embodiment of the present disclosure;

FIGS. 4 to 6 are views for describing a method for manufacturing an electrode assembly according to an embodiment of the present disclosure; and

FIG. 7 is a perspective view of an electrode assembly according to another embodiment of the present disclosure.

### DETAILED DESCRIPTION OF THE PREFERRED EMBODIMENT

Hereinafter, embodiments of the present disclosure will be described in detail with reference to the accompanying drawings so as to be easily carried out by a person skilled in the art to which the present disclosure pertains . However, the present disclosure may be embodied in various different forms, and is neither limited nor restricted to the following embodiments.

In order to clearly describe the present disclosure, detailed description of parts irrelevant to the disclosure or detailed descriptions of related well-known technologies that may unnecessarily obscure subject matters of the disclosure will be omitted. In the specification, when reference numerals are given to components in each of the drawings, the same or similar components will be designated by the same or similar reference numerals throughout the specification.

Also, terms or words used in this specification and claims should not be restrictively interpreted as ordinary meanings or dictionary-based meanings, but should be interpreted as meanings and concepts conforming to the technical ideas of the present disclosure on the basis of the principle that an inventor can properly define the concept of a term so as to describe his or her invention in the best ways.

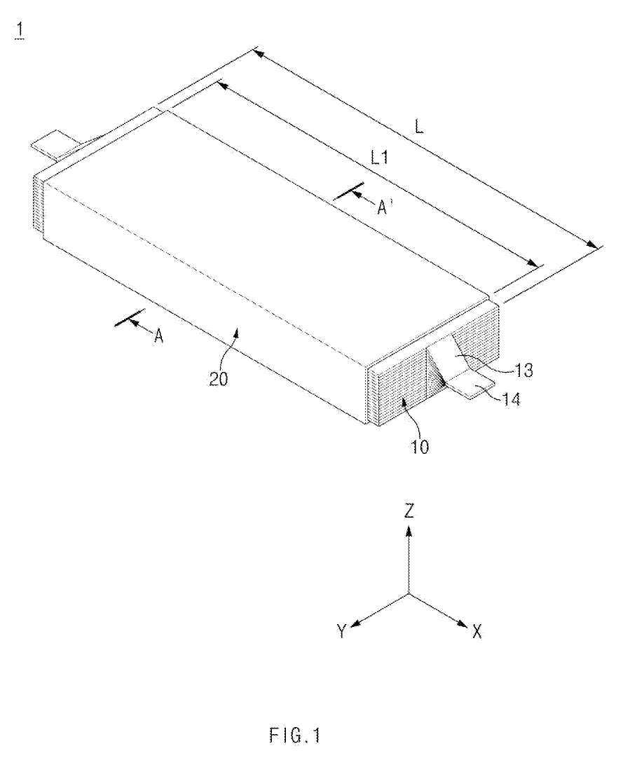

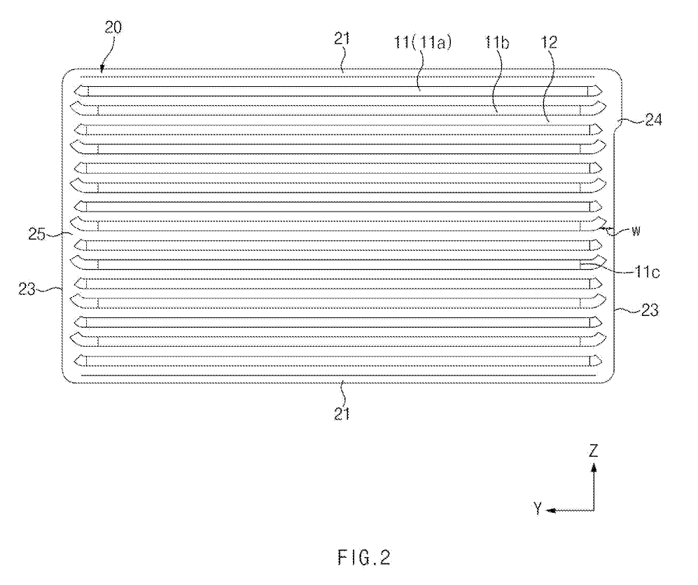

FIG. 1 is a perspective view of an electrode assembly according to an embodiment of the present disclosure, and FIG. 2 is a cross-sectional view taken along line A-A′ of FIG. 1.

An electrode assembly 1 according to an embodiment of the present disclosure may include a stack 10, in which a plurality of electrodes 11 and a plurality of separators 12 are alternately stacked on each other, and a wrapping separator 20, which surrounds the stack 10 and is fused with at least some of the plurality of separators 12.

The plurality of electrodes 11 may include negative electrodes 11a and positive electrodes 11b which are alternately stacked on each other. Each of the negative electrodes 11a may be formed by applying a negative electrode active material onto a negative electrode current collector (e.g., copper thin plate), and each of the positive electrodes 11b may be formed by applying a positive electrode active material onto a positive electrode current collector (e.g., an aluminum thin plate).

Electrode tabs 13 may be connected to respective electrodes 11. An electrode tab 13 connected to the negative electrode 11a may be a portion which is not coated with the negative electrode active material and allows the negative electrode current collector to be exposed. An electrode tab 13 connected to the positive electrode 11b may be a portion which is not coated with the positive electrode active material and allows the positive electrode current collector to be exposed.

The plurality of electrode tabs 13 having the same polarity may be electrically connected to each other and protrude from the stack 10 in the longitudinal direction. The plurality of electrode tabs 13 may act as a path through which electrons can move between the inside and outside of the stack 10.

The plurality of electrode tabs 13 connected to the negative electrodes 11a and the plurality of electrode tabs 13 connected to the positive electrodes 11b may protrude in directions different from each other with respect to the stack 10. However, the embodiment is not limited thereto, and the plurality of electrode tabs 13 connected to the positive electrodes 11b and the plurality of electrode tabs 13 connected to the negative electrodes 11a may be spaced apart from each other and protrude side by side in the same direction with respect to the stack 10.

Leads 14, which supply electricity to the outside of the electrode assembly 1, are connected to the plurality of electrode tab 13 through spot welding and the like. In more detail, one lead 14 may be connected to the plurality of electrode tabs 13 connected to the positive electrodes 11b, and another lead 14 may be connected to the plurality of electrode tabs 13 connected to the negative electrodes 11a.

Each of the separators 12 may be provided in the form of a porous membrane and include a polyolefin-based material, more specifically, a polypropylene (PP) or polyethylene (PE) material.

The area of each separator 12 may be larger than the area of the electrode 11. That is, the edge of each separator 12 may protrude further outward than the electrode 11.

Also, the edges of at least some of the plurality of separators 12 may be fused with a wrapping separator 20, which will be described later, to form fused portions 25. In more detail, the edges of at least some of the plurality of separators 12 on both sides in the width direction may form the fused portions 25 which are integrally connected to the wrapping separator 20.

Since the edges of the separators 12 are fixed, it is possible to prevent a short circuit from occurring in the electrodes 11 due to unintentional tearing or folding of the separators 12.

The wrapping separator 20 may surround the stack 10 in the width direction and may be integrally connected to at least some of the plurality of separators 12. Accordingly, the stack 10 may maintain an aligned state during stacking, and the electrode assembly 1 may maintain high stiffness. Therefore, it is possible to minimize bending of the electrode assembly 1.

The wrapping separator 20 may be provided in the form of a porous membrane and include a polyolefin-based material, more specifically, a polypropylene (PP) or polyethylene (PE) material. Preferably, the wrapping separator 20 may include the same material as the separators 12 of the stack 10.

Therefore, an electrolyte, which is accommodated in a case (not shown) together with the electrode assembly 1, may permeate the wrapping separator 20 and easily infiltrate into the stack 10.

The wrapping separator 20 may have a certain length L1 in the longitudinal direction of the stack 10. In order to sufficiently secure the effect of increasing the stiffness of the electrode assembly 1, the length L1 of the wrapping separator 20 may be greater than about 0.5 times, preferably about 0.7 times the full length L of the stack 10. In particular, when the length L1 of the wrapping separator 20 is greater than or equal to the full length L of the stack 10, the wrapping separator 20 may completely surround the stack 10.

The wrapping separator 20 may include a pair of unfused surfaces 21, which cover both surfaces of the stack 10, and a pair of fused surfaces 23, which cover both sides of the stack 10 in the width direction. The pair of unfused surfaces 21 and the pair of fused surfaces 23 may be integrally connected to each other.

The pair of unfused surfaces 21 may cover both surfaces of the stack 10, that is, the electrode 11 or the separator 12 which is positioned at the outermost side. Also, the pair of unfused surfaces 21 may not be fused with both surfaces of the stack 10, that is, the electrode 11 or the separator 12 which is positioned at the outermost side.

The pair of fused surfaces 23 may connect the pair of unfused surfaces 21 to each other. The fused portions 25, which are fused to the edges of the separators 12 that protrude from both sides of the stack 10 in the width direction, may be formed in each of the fused surfaces 23.

The fused portions 25 may be formed by laser welding in a state in which the wrapping separator 20 presses the edges of the plurality of separators 12. In more detail, in a state in which the edges of the plurality of separators 12 are curved or bent, at least one of the edges of the separators 12 or the wrapping separator 20 may be melted by absorbing energy of laser beams. Accordingly, the edges of the separators 12 and the wrapping separator 20 may be fused with each other to form the fused portions 25.

Therefore, the fused portions 25 may be in contact with or adjacent to ends 11c of at least some of the plurality of electrodes 11. Accordingly, empty spaces between the wrapping separator 20 and the ends 11c of the electrodes 11 are minimized, and thus, the width of the electrode assembly 1 is reduced, and the energy density is increased.

Also, the edges of the plurality of separators 12 pressed by the wrapping separator 20 are irregularly bent or curved, and thus, the fused portions 25 formed in this state may have random cross-sectional shapes. In more detail, widths w of the fused portions 25 in a direction parallel to the width direction of the stack 10 may not be constant but variable along a stacking direction of the stack 10.

Also, the separators 12 and the wrapping separator 20 are fused with each other by the laser welding, and thus, a separate adhesive is not necessary. That is, the fused portions 25 do not include an adhesive.

Hereinafter, a method for manufacturing the electrode assembly 1 will be described.

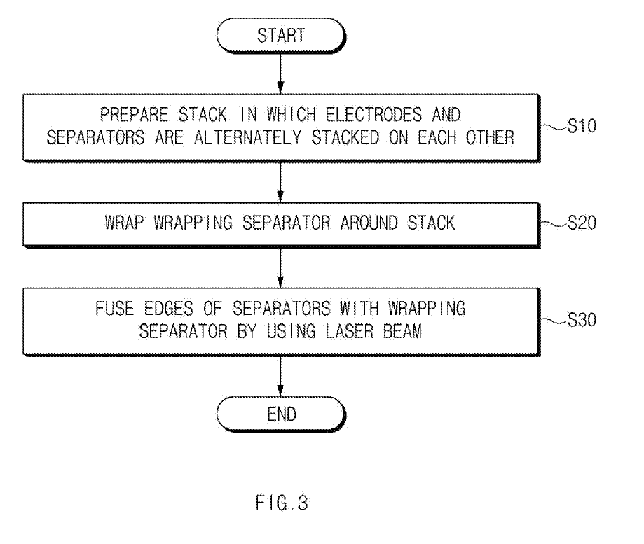

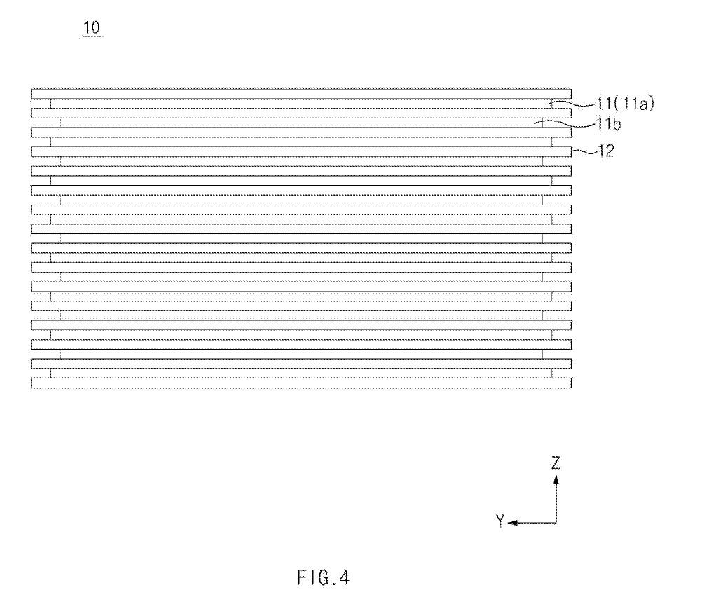

FIG. 3 is a flowchart of a method for manufacturing an electrode assembly according to an embodiment of the present disclosure, and FIGS. 4 to 6 are views for describing a method for manufacturing an electrode assembly according to an embodiment of the present disclosure.

The method for manufacturing an electrode assembly according to an embodiment of the present disclosure may include a preparation operation (S10), a wrapping operation (S20), and a fusing operation (S30).

In the preparation operation (S10), a stack 10 is prepared. As illustrated in FIG. 4, the stack 10 may be formed by alternately stacking a plurality of electrodes 11 and a plurality of separators 12 on each other. In this case, the edges of separators 12 may protrude further outward than the electrodes 11.

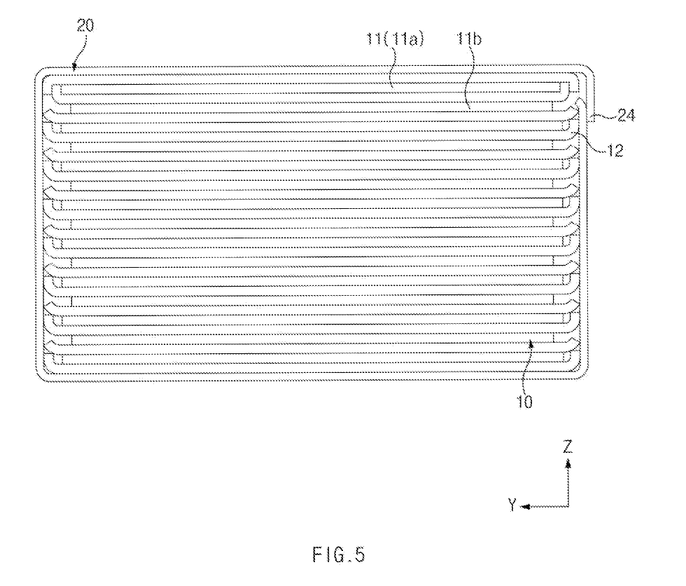

In the wrapping operation (S20), a wrapping separator 20 is wrapped around the stack 10. As illustrated in FIG. 5, the wrapping separator 20 may cover both surfaces of the stack 10 and both sides thereof in the width direction. Here, the edges of the plurality of separators 12 may be irregularly bent or curved by the wrapping separator 20.

During the wrapping operation (S20), an overlapping portion 24, in which both ends of the wrapping separator 20 overlap each other, may be fixed so that the wrapping of the wrapping separator 20 is not loosened. A means for fixing the overlapping portion 24 is not limited.

In one example, as illustrated in FIG. 5, the overlapping portion 24 may be positioned on one side of the stack 10 in the width direction. In this case, the overlapping portion 24 may be melted in the subsequent fusing operation (S30) and included in fused surfaces 23 (see FIG. 2). Accordingly, the appearance of the electrode assembly 1 becomes neat.

In another example, the overlapping portion 24 may be positioned on the upper side or lower side of the stack 10. Therefore, the wrapping separator 20 may be more strongly pressed against the edges of the separators 12 compared to the one example described above. Accordingly, the width of the electrode assembly 1 is further reduced, and the energy density is increased.

In the fusing operation (S30), the edges of at least some of the plurality of separators 12 are fused with the wrapping separator 20 by using the laser beam. The edges of at least some of the plurality of separators 12 may be fused with the wrapping separator 20 in a curved or bent state.

In more detail, at least one of the edges of the separators 12 or the wrapping separator 20 may be melted by absorbing energy of a laser beam B, and accordingly, the fused portions 25 (see FIG. 2), in which the wrapping separator 20 and the edges of the separators 12 are fused with each other, may be formed.

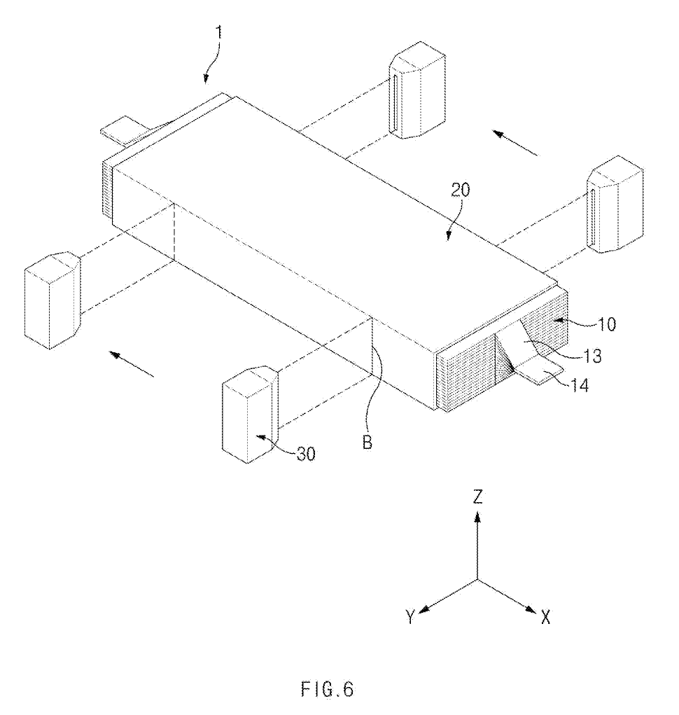

Referring to FIG. 6, the fusing operation (S30) may include focusing the laser beam B in a line shape on the outer surface of the wrapping separator 20 and performing scanning while moving the laser beam B in the longitudinal direction of the stack 10.

A laser unit 30 for emitting the laser beam B may be positioned on one side or both sides of the electrode assembly 1 in the width direction, and may face the side surface of the wrapping separator 20. The configuration of the laser unit 30 is not limited.

The laser unit 30 may emit the laser beam B onto the side surface of the wrapping separator 20 in a state in which a fixing jig (not shown) supports or presses the electrode assembly 1 at both sides in the width direction. The configuration of the fixing jig is not limited, and in one example, an opening portion that prevents the interference with the laser beam B may be formed in the fixing jig.

The laser beam B emitted from the laser unit 30 may be focused, in a line shape, on the outer surface of the wrapping separator 20. For example, the laser beam B may be focused in a line shape that extends in a stacking direction of the stack 10.

The position and number of the separators 12 fused with the wrapping separator 20 may be determined according to the position and length of the laser beam B focused on the outer surface of the wrapping separator 20.

Also, as illustrated in FIG. 6, the laser unit 30 may perform scanning while moving the laser beam B in the longitudinal direction of the stack 10.

Therefore, each of the fused portions 25 may be elongated in the longitudinal direction of the stack 10. The length of the fused portion 25 in the longitudinal direction of the stack 10 may be determined according to a region scanned by the laser beam B. That is, the fused region between the wrapping separator 20 and the separators 12 of the stack 10 may be easily adjusted by adjusting the region scanned by the laser beam B.

In more detail, the laser unit 30 may move in the longitudinal direction of the stack 10 while emitting the laser beam B. However, the embodiment of the present disclosure is not limited thereto, and the laser unit 30 may be provided with a mechanism capable of adjusting the emitting direction or emitting angle of the laser beam B.

In order to prevent the laser beam B from being directly emitted onto the stack 10, the region to be scanned by the laser beam B does not extend beyond both ends of the wrapping separator 20 in the length direction. Preferably, the region to be scanned by the laser beam B may be located inside both ends of the wrapping separator 20 in the length direction. Therefore, the length of the fused portion 25 may be less than or equal to the length L1 (see FIG. 1) of the wrapping separator 20.

When the fusing operation (S30) is completed, an electrode assembly 1 may be manufactured, in which at least some of the plurality of separators 12 of the stack 10 are integrally connected to the wrapping separator 20. As the separators 12 of the stack 10 are connected to the wrapping separator 20, the stiffness of the electrode assembly 1 may be maintained high, and the bending thereof may be minimized.

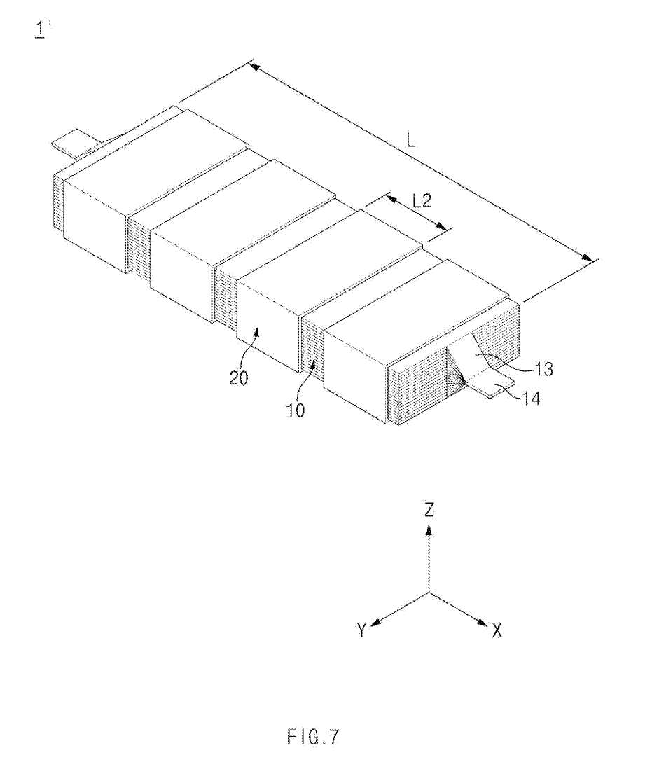

FIG. 7 is a perspective view of an electrode assembly according to another embodiment of the present disclosure.

The embodiment is the same as the one embodiment described above, except that a plurality of wrapping separators 20 are provided spaced apart from each other in the longitudinal direction of a stack 10. Therefore, the features overlapping those described above will be applied to the embodiment, and differences therebetween will be mainly described.

An electrode assembly 1' according to the embodiment may include a plurality of wrapping separators 20 that are spaced apart from each other in the longitudinal direction of a stack 10. Therefore, an electrolyte (not shown) may more easily infiltrate into the stack 10 via spaces between the plurality of wrapping separators 20.

Also, each of the wrapping separators 20 may be integrally connected to at least some of a plurality of separators 12 included in the stack 10.

The sum of lengths L2 of the plurality of wrapping separators 20 may be greater than about 0.5 times, preferably about 0.7 times the full length L of the stack 10. Accordingly, the effect of increasing the stiffness of the electrode assembly 1' may be sufficiently secured by the plurality of wrapping separators 20.

It is preferable that each of the wrapping separators 20 has a constant length L2 in the longitudinal direction of the stack 10. However, the embodiment of the present disclosure is not limited thereto, and the plurality of wrapping separators 20 may have different lengths L2.

According to the embodiment of the present disclosure, the wrapping separator is integrally connected to the separators of the stack, and thus, the stiffness of the electrode assembly may be enhanced. Therefore, it is possible to minimize the bending of the electrode assembly.

Also, the edges of the separators of the stack are integrally connected and fixed to the wrapping separator, and thus, it is possible to prevent the short circuit from occurring in the electrodes due to unintentional tearing or folding of the edges of the separators.

In addition, the wrapping separator includes the porous membrane, and thus, the electrolyte may permeate the wrapping separator and easily infiltrate into the stack. Therefore, it is possible to maintain the high performance of the electrode assembly.

Furthermore, the wrapping separator is fused with the separators of the stack through the laser welding, and thus, a separate adhesive is not necessary. Therefore, it is possible to prevent the deterioration of the performance of the electrode assembly which may occur when the adhesive is used.

In addition to the effects described above, effects that can be easily predicted by those skilled in the art from the configurations according to the embodiments of the present disclosure may be included.

The technical ideas of the present disclosure have been described merely for illustrative purposes, and those skilled in the art will appreciate that various changes and modifications are possible without departing from the essential features of the present disclosure.

Thus, the embodiments of the present disclosure are to be considered illustrative and not restrictive, and the technical idea of the present disclosure is not limited to the foregoing embodiments.

The protective scope of the present disclosure is defined by the appended claims, and all technical ideas within their equivalents should be interpreted as being included in the scope of the present disclosure.

### Description of the Reference Numerals

1: electrode assembly 10: stack
11: electrode 12: separator
20: wrapping separator 21: unfused surface
23: fused surface 24: overlapping portion
25: fused portion 30: laser unit

1. An electrode assembly comprising:
a stack in which a plurality of electrodes and a plurality of separators are alternately stacked on each other, wherein edges of the separators protrude further outward than the electrodes in a width dimension orthogonal to a stacking dimension of the stack; and
a wrapping separator configured to surround the stack,
wherein the edges of at least some of the plurality of separators are fused with the wrapping separator to form fused portions.

2. The electrode assembly of claim 1, wherein the wrapping separator asand the separators comprise the same material.

3. The electrode assembly of claim 1, wherein the wrapping separator surrounds the stack such that:
a pair of unfused surfaces of the wrapping separator is configured to cover opposing surfaces of the stack in the stacking dimension; and
a pair of fused surfaces of the wrapping separator is configured to cover opposing sides of the stack in the width dimension and connect the pair of unfused surfaces to each other,
wherein the fused portions are formed alongthe fused surfaces.

4. The electrode assembly of claim 1, wherein the fused portions are in contact with or adjacent to ends of at least some of the plurality of electrodes.

5. The electrode assembly of claim 1, wherein a widths of the fused portions in a directionthe width dimension parallel to the width dimension of the stack are not uniform along a stacking direction of the stack.

6. The electrode assembly of claim 1, wherein a length of the wrapping separator in a longitudinal dimension of the stack is greater than or equal to 0.5 times a length of the stack in the longitudinal dimension, the longitudinal dimension being orthogonal to both the width dimension and the stacking dimension.

7. The electrode assembly of claim 1, wherein the wrapping separator is provided in a plurality, and the plurality of wrapping separators are spaced apart from each other in a longitudinal dimension of the stack, the longitudinal dimension being orthogonal to both the width dimension and the stacking dimension.

8. The electrode assembly of claim 1, wherein a respective lengths of each of the fused portions in a longitudinal dimension of the stack is less than or equal to a length of the wrapping separator in the longitudinal dimension, the longitudinal dimension being orthogonal to both the width dimension and the stacking dimension.

9. A method for manufacturing an electrode assembly, the method comprising:
alternately stacking a plurality of electrodes and a plurality of separators along a stacking dimension, whereinedges of the separators protrude further outward than the electrodes in a width dimension orthogonal to the stacking dimension;
wrapping a wrapping separator around the stack; and
fusing the edges of at least some of the plurality of separators with the wrapping separator by a laser beam.

10. The method of claim 9, wherein the wrapping step comprises:
covering opposing surfaces of the stack in the stacking dimension with the wrapping separator, and covering opposing sides of the stack in the width directiondimension with the wrapping separator.

11. The method of claim 9, wherein the fusing step comprises:
focusing the laser beam in a line shape on an outer surface of the wrapping separator; and
scanning while moving the laser beam in a longitudinal dimension of the stack, the longitudinal dimension being orthogonal to both the width dimension and the stacking dimension.

12. The method of claim 9, wherein the edges of the plurality of separators are pressed and folded by the wrapping separator during the wrapping step, and
the edges of at least some of the plurality of separators are fused, in a curved or bent state, with the wrapping separator during the fusing step.
